(19) United States
(12) Patent Application Publication
(10) Pub. No.: US 2015/0363322 A1
(43) Pub. Date: Dec. 17, 2015

(54) SYSTEMS, METHODS, AND COMPUTER PROGRAMS FOR PROVIDING CLIENT-FILTERED CACHE INVALIDATION

(71) Applicant: QUALCOMM INCORPORATED, San Diego, CA (US)

(72) Inventors: LEE WILLIAM HOWES, SAN JOSE, CA (US); BENEDICT RUEBEN GASTER, SANTA CRUZ, CA (US); DEREK ROBERT HOWER, DURHAM, NC (US)

(21) Appl. No.: 14/337,108

(22) Filed: Jul. 21, 2014

Related U.S. Application Data
(60) Provisional application No. 62/012,139, filed on Jun. 13, 2014.

(51) Int. Cl. G06F 12/08

(52) U.S. Cl. CPC G06F 12/0891; G06F 12/0897; G06F 2212/502

(57) ABSTRACT

A method and system includes generating a cache entry comprising cache line data for a plurality of cache clients and receiving a cache invalidate instruction from a first of the plurality of cache clients. In response to the cache invalidate instruction, the data valid/invalid state is changed for the first cache client to an invalid state without modifying the data valid/invalid state for the other of the plurality of cache clients from the valid state. A read instruction may be received from a second of the plurality of cache clients and in response to the read instruction, a value stored in the cache line data is returned to the second cache client while the data valid/invalid state for the first cache client is in the invalid state and the data valid/invalid state for the second cache client is in the valid state.

### CROSS-REFERENCE TO RELATED APPLICATIONS

This application claims the benefit of priority under 35 U.S.C. §119(e) to U.S. Provisional Patent Application No. 62/012,139, entitled “Systems, Methods, and Computer Programs for Providing Client-Filtered Cache Invalidation” and filed on Jun. 13, 2014 (Attorney Docket No. 17006.0343U1), which is hereby incorporated by reference in its entirety.

### DESCRIPTION OF THE RELATED ART

Portable computing devices (e.g., cellular telephones, smart phones, tablet computers, portable digital assistants (PDAs), and portable game consoles) continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising one or more chip components embedded on a single substrate (e.g., one or more central processing units (CPUs), a graphics processing unit (GPU), digital signal processors, etc.).

Such devices typically employ cache memory and a cache controller designed to reduce the time for accessing a main memory. As known in the art, cache is a smaller, faster memory which stores copies of the data from frequently used memory locations. When a memory client needs to read from or write data to a location in the main memory, the cache controller checks whether a copy of that data is in the cache memory. If so, the memory client reads from or writes to the cache. If a copy is not in the cache, a new cache entry is allocated and the data is transferred from the main memory to the cache. Cache memory may be organized as a hierarchy of increasingly slower but larger cache levels (e.g., level one (L1), level two (L2), level three (L3), etc.). Multi-level caches generally operate by checking the fastest L1 cache first. If there is a cache hit, the processor proceeds at high speed. If the smaller L1 cache does not produce a cache hit, the next fastest L2 cache is checked, and so on, before external memory is checked. Furthermore, the number of clients associated with a given cache generally grows with the cache level, and each set of clients is a subset of the clients in the next cache level. For example, the clients of a given L2 cache are a subset of the clients in the associated L3 cache.

Some multi-level cache systems may incorporate techniques for ensuring that memory will be consistent among multiple cache clients and that the results of memory operations will be predictable provided the memory consistency programming rules are followed. However, existing techniques are relatively coarse-grained, which results in several disadvantages. For example, a given cache client may synchronize with all clients of the L3 cache by flushing (e.g., cleaning dirty lines or invalidating read lines) from the L2 cache. Each L2 cache itself may support a number of memory clients, each of which may carry a predetermined number of threads or wavefronts, resulting in a large number of cache clients that may be reading and writing data. Any one of those clients may issue a cache clean or invalidate to guarantee memory consistency ordering. The cost of this event is that data is cleaned or invalidated across the entire L2 cache for every client, even those that are not synchronizing.

Accordingly, there is a need for improved systems, methods, and computer programs for providing cache invalidation.

### SUMMARY

Systems, methods, and computer programs are disclosed for providing client-filtered cache invalidation. One embodiment is a system for invalidating cache line data in a cache entry. One such system comprises a plurality of memory clients for accessing a main memory. A cache controller transfers data between the main memory and a cache memory. The cache controller comprises a client-filtered cache invalidation component comprising logic configured to: generate a cache entry in the cache memory, the cache entry comprising cache line data for a plurality of cache clients; set a data valid/invalid state for each of the plurality of clients to a valid state; receive a cache invalidate instruction from a first of the plurality of cache clients; in response to the cache invalidate instruction, change the data valid/invalid state for the first cache client to an invalid state without modifying the data valid/invalid state for the other of the plurality of cache clients from the valid state; receive a read instruction to the cache entry from a second of the plurality of cache clients; and in response to the read instruction, return a value stored in the cache line data to the second cache client while the data valid/invalid state for the first cache client is in the invalid state and the data valid/invalid state for the second cache client is in the valid state.

Another embodiment is a method for invalidating cache line data in a cache entry. One such method comprises: generating a cache entry comprising cache line data for a plurality of cache clients; setting a data valid/invalid state for each of the plurality of clients to a valid state; receiving a cache invalidate instruction from a first of the plurality of cache clients; in response to the cache invalidate instruction, changing the data valid/invalid state for the first cache client to an invalid state without modifying the data valid/invalid state for the other of the plurality of cache clients from the valid state; receiving a read instruction to the cache entry from a second of the plurality of cache clients; and in response to the read instruction, returning a value stored in the cache line data to the second cache client while the data valid/invalid state for the first cache client is in the invalid state and the data valid/invalid state for the second cache client is in the valid state.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing client-filtered cache invalidation.

FIG. 2 is a block diagram illustrating an exemplary implementation of the client-filtered cache invalidation component in a multi-level cache.

FIG. 3 is a flowchart illustrating the architecture, operation, and/or functionality of an embodiment of the client-filtered cache invalidation component in the system of FIG. 1.

FIG. 4 is a block diagram of an embodiment of a data structure for managing the data valid/invalid states of a cache entry for a plurality of cache clients.

FIG. 5 is an embodiment of a cache entry structure for providing client-filtered cache invalidation.

FIG. 6 illustrates another embodiment of a cache entry structure during an exemplary sequence of cache operations.

FIG. 7 is a block diagram of an embodiment of a portable computer device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

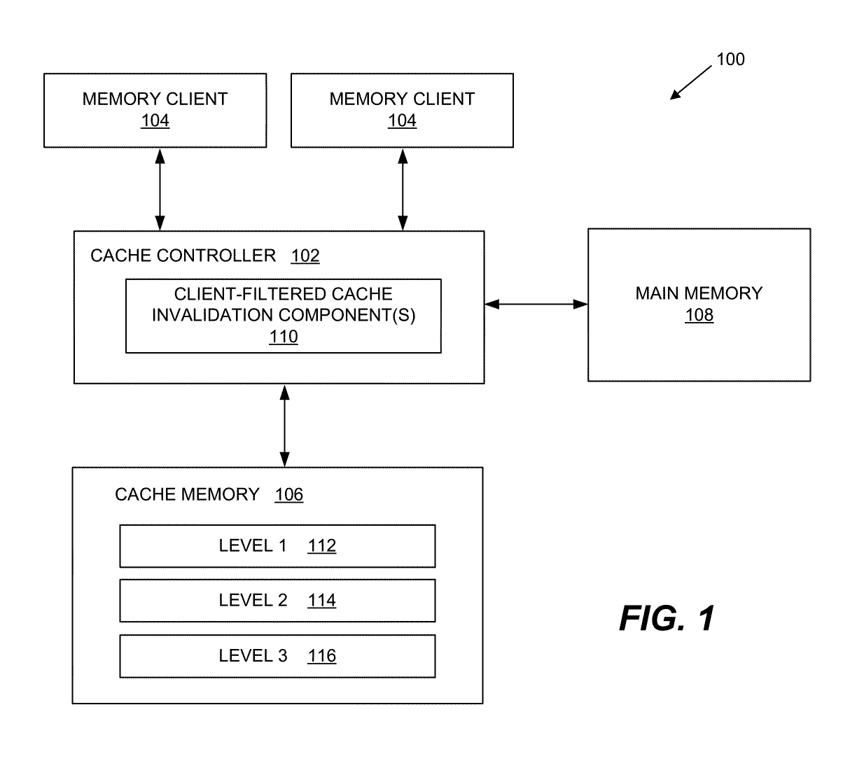

FIG. 1 illustrates an embodiment of a cache system 100 for providing on-demand, client-filtered cache invalidation. As described below in more detail, the cache system 100 enables individual clients of a cache to invalidate cache data without invalidating the cache data needed by other clients of the cache. The cache system 100 may be implemented in any computing system, distributed computing system, or computing device, including a personal computer, a workstation, a server, a portable computing device (PCD), such as a cellular telephone, a smart phone, a portable digital assistant (PDA), a portable game console, a palmtop computer, or a tablet computer.

As illustrated in FIG. 1, the cache system 100 comprises a plurality of memory clients 104 that read data from and write data to a main memory 108. The memory clients 104 may comprise one or more processing units (e.g., central processing unit (CPU), graphics processing unit (GPU), digital signal processor (DSP), mobile display processor, etc.), a video encoder, or other clients requesting read and/or write access to the main memory 108. A cache controller 102 is configured to control and manage the operation of a cache memory 106, which may comprise one or more cache levels (e.g., a level 1 (L1) cache(s) 112, level 2 (L2) cache(s), level 3 (L3) cache(s), etc.). In an embodiment, the system 100 may comprise a plurality of cache controllers 102. Each cache level may have a cache controller 102 and/or each instance of a cache within each cache level may have a cache controller 102. The cache controller 102 may interface with the memory clients 104, the cache memory 106, and the main memory 108 via hardware connections, buses, interconnects, etc. or via software interfaces.

As further illustrated in FIG. 1, the cache controller 102 comprises client-filtered cache invalidation component(s) 110, which generally comprises logic (e.g., hardware, software, firmware, or any combination thereof) for providing on-demand cache consistency via client-filtered cache invalidation. As mentioned above, the client-filtered cache invalidation component(s) 110 enable an individual client of a cache to request data invalidation without invalidating data needed by other clients of the cache. In this manner, the cache system 100 provides on-demand ordering with respect to a given cache client while maintaining temporal locality for other cache clients.

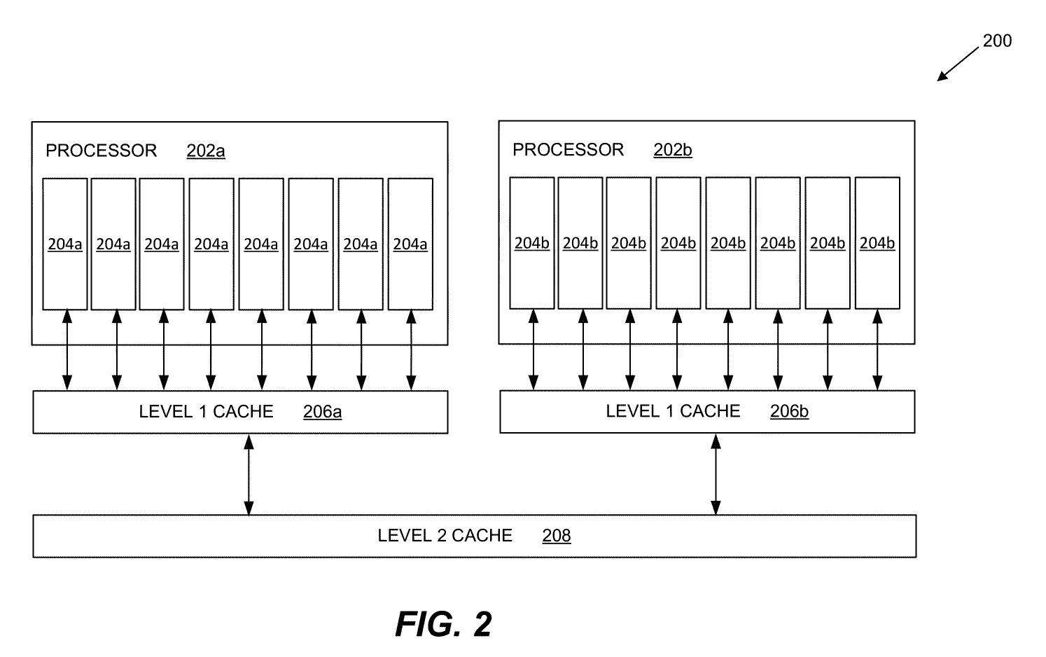

FIG. 2 illustrates an exemplary implementation of a multi-level cache to illustrate the general principles of the client-filtered cache invalidation scheme controlled and managed by the cache controller 102. As illustrated in FIG. 2, each level 1 cache has a processor as a cache client. Processor 202a is a client of level 1 cache 206a, and processor 202b is a client of level 1 cache 206b. Each processor 202a and 202b may support a plurality of threads or wavefronts with the corresponding cache. It should be appreciated that any number of threads may be supported. In the embodiment of FIG. 2, processor 202a supports eight threads 204a with level 1 cache 206a, and processor 202b supports eight threads 204b with level 1 cache 206b. A level 2 cache 208 has two L1 clients (i.e., level 1 caches 206a and 206b) or a total of sixteen threads. One of ordinary skill in the art will appreciate that the number of L1 clients, L2 clients, cache levels, and supported threads may be modified. Any of the threads and/or cache levels may be referred to as a cache client.

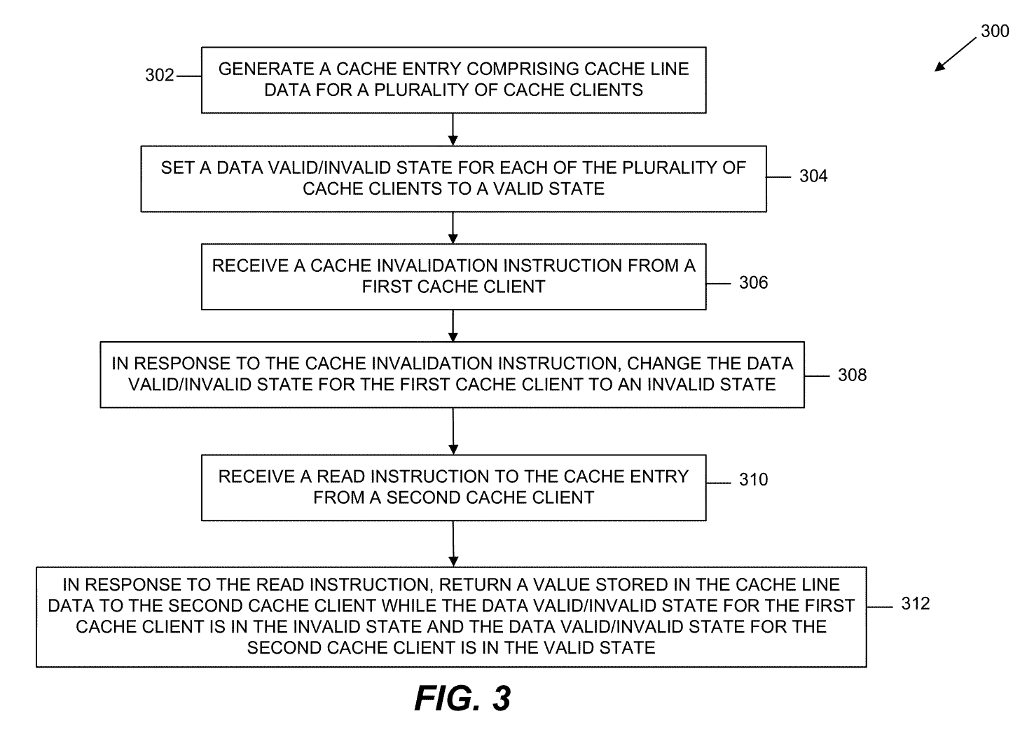

FIG. 3 is a flowchart 300 illustrating an embodiment of the architecture, operation, and/or functionality of the client-filtered cache invalidation component(s) 110. At block 302, a new cache entry for cache memory 106 is generated. The cache entry may be associated with a level 1 cache 206, a level 2 cache 208, etc. Data is transferred between the main memory 108 and the cache memory 106 in blocks of fixed size, referred to as cache lines. When a cache line is copied from the main memory 108 into the cache memory 106, a cache entry is generated. The cache entry comprises the copied data (i.e., cache line data) as well as the requested memory location, referred to as a linetag. In this regard, the new cache entry comprises cache line data for the plurality of corresponding cache clients.

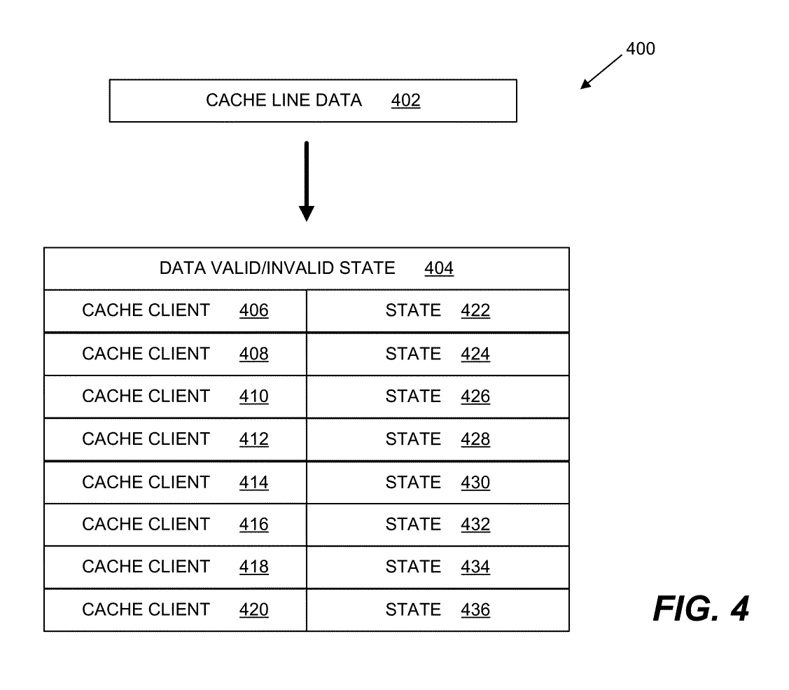

For each cache entry, the client-filtered cache invalidation component 110 maintains a data valid state or a data invalid state for each of the plurality of associated cache clients. The data valid/invalid state for a given cache client indicates whether or not the cache line data is deemed valid or invalid. FIG. 4 illustrates an exemplary embodiment of a data structure 400 for managing data valid/invalid states 404 for a plurality of cache clients associated with a cache entry's cache line data 402. The embodiment of FIG. 4 corresponds to a cache entry associated with a level 1 cache 206 (FIG. 2), which comprises eight cache clients 406, 408, 410, 412, 414, 416, 418, and 420 (corresponding to the eight threads 204 supported by a processor 202). Data valid/invalid states 422, 424, 426, 428, 430, 432, 434, and 436 maintain state data for cache clients 406, 408, 410, 412, 414, 416, 418, and 420, respectively.

Referring again to FIG. 3, when a new cache entry is generated and loaded with the cache line data 402, the data valid/invalid state for each of the associated cache clients may be initially set to the valid state (block 304). At block 306, a cache invalidation instruction may be received from a cache client 406. In response to the cache invalidation instruction, the state 422 for cache client 406 is changed from the valid state to an invalid state. As mentioned above, the client-filtered cache invalidation component 110 enables an individual client of a cache to request data invalidation without invalidating data needed by other clients of the cache. In this regard, it should be appreciated that the data valid/invalid state for the other cache clients 408, 410, 412, 414, 416, 418, and 420 may remain in the valid state. If a read instruction to the cache entry is received (block 310) from, for example, a cache client 408 while the cache client 406 is in the invalid state, the cache controller 102 may return valid data to the cache line 408. At block 312, in response to the read instruction, the cache controller 102 may return a value stored in the cache line data 402 to the cache client 408 while cache client 406 is in the invalid state.

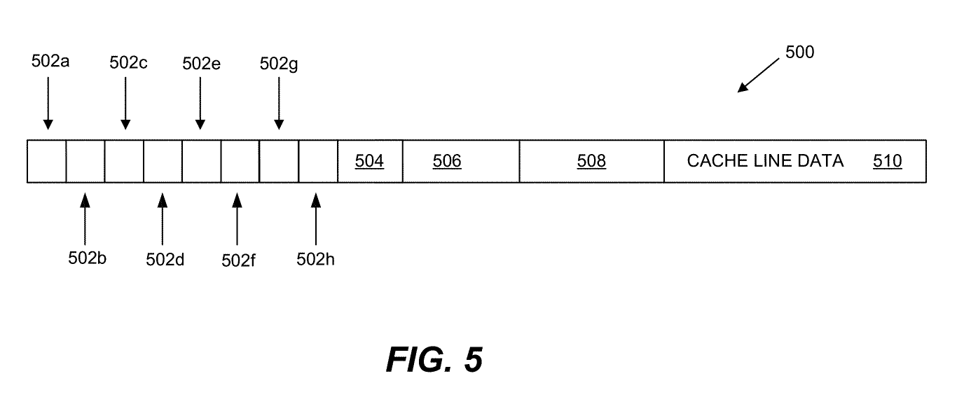

FIG. 5 illustrates an embodiment of a cache entry structure 500 for implementing the client-filtered cache invalidation generally described above. The cache entry structure 500 comprises a dirty bit field 504, a dirty byte mask field 506, a linetag field 508, and a cache line data field 510. The cache line data field 510 comprises the actual data fetched from the main memory 108. The linetag field 508 comprises the memory address of the actual data fetched from the main memory 108. The dirty bit field 504 indicates whether the cache block has been unchanged since it was read from the main memory (i.e., “clean”) or whether one of the cache clients has written data to the cache block and the new value has not yet made it to the main memory 108 (i.e., “dirty”). The dirty byte mask field 506 comprises a bit per byte in the cache line representing which byte was written to when the dirty bit (field 504) is updated to the dirty state. The dirty byte mask field 506 enables the dirty data from two cache clients to correctly merge their updates in an outer cache level.

As further illustrated in FIG. 5, the cache entry structure 500 further comprises a valid bit for each cache client. Following the example of FIG. 4 in which the cache entry has eight cache clients, the cache entry structure 500 comprises eight valid bit fields 502a, 502b, 502c, 502d, 502e, 502f, 502g, and 502h. A valid bit value=1 corresponds to a data valid state, and a valid bit value=0 corresponds to an invalid state. It should be appreciated that the number of valid bit fields may vary depending on the cache-level structure, number of threads per processor, etc., as well as the granularity of optimization desired for trading off temporal locality and cache state.

One of ordinary skill in the art will appreciate that various cache instructions may be employed by the memory clients 104, cache controller 102, client-filtered cache invalidation component 110, etc. For example, in an embodiment, read/write fences or similar structures may be encoded to explicitly perform a cache invalidate. A cache invalidate instruction may comprise a cache client identifier flag, which may be explicitly passed to the instruction or implicitly determined based on a path through the cache hierarchy taken by the operation. Each layer of a cache hierarchy may be one client of the next level down or expose multiple clients (e.g., the threads 204). An invalidate operation may be generated by a synchronizing load or an acquire operation in a release consistency memory model.

An exemplary implementation of a read request from a cache client to the client-filtered cache invalidation component 110 may comprise the following:

If(line is in cache) {

If(valid bit c is set) {

Return data;

} else {

Invalidate entire line and re-request from next level of hierarchy.
Set valid bits for all clients to 1 and return new data.

}

} else {

Request line from next level of hierarchy.
Set valid bits for all clients to 1 and return next data.

}

An exemplary implementation of a cache invalidation instruction from a cache client c to the client-filtered cache invalidation component 110 may comprise the following:

For all cache lines {

Set valid bit c for cache line to 0

}

An exemplary implementation of a write to the cache from a cache client may comprise the following:

Set the dirty bit for the cache line.
Leave valid bit unmodified.

In operation, an invalidate instruction only sets the valid bit for the requesting cache client to invalid. The other cache clients would still see the cache line as valid and, therefore, read the data from it unless they also request an ordering guarantee. Their own reads that rely on temporal locality would not be affected because that data is not part of the invalid client's working set. A read of the same cache line from the invalidating client would see the bit as unset and request an update. This procedure may be followed even if all cache lines are invalidated

Writes to the cache, act as updates from a further cache level except that they also mark the line as dirty for future clean operations to flush the data out. Written data is fresh and if the line was valid it may stay valid.

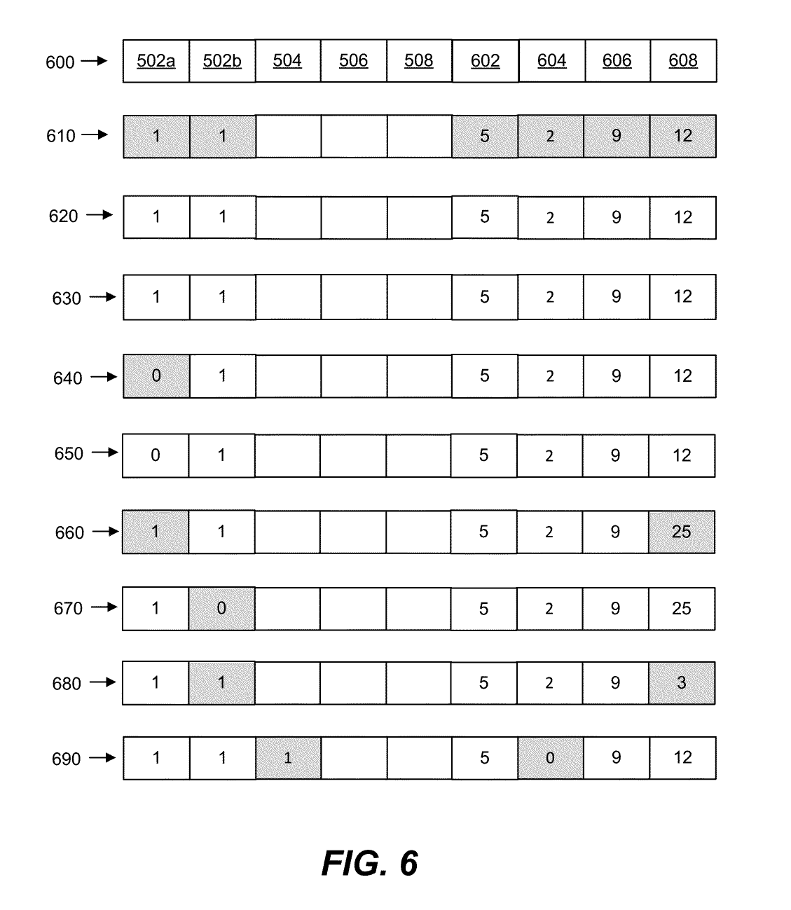

FIG. 6 illustrates a simplified cache entry structure 600 comprising only two valid bit fields 502a and 502b for cache clients 0 and 1, respectively. The cache line data 510 comprises data fields 602, 604, 606, and 608 defining values for respective memory locations. The operation of another embodiment of the client-filtered cache invalidation component 110 will be described with reference to a series of cache entry operation sequences 610, 620, 630, 640, 650, 660, 670, 680, and 690.

In sequence 610, one of the clients, either a or b, reads from a cache line and the line is brought into the cache. Valid bits 502a and 502b are both set to valid as the cache line is fresh. Sequences 620 and 630 show clients a and b reading from the cache line. Read operations from valid lines require no state changes. At sequence 640, client a causes an invalidation of cache data and the valid state a for the line is updated to invalid. Valid bit b is unchanged. In sequence 650, client b may read from the line with no change to cache state because valid bit b is still in the valid state. In sequence 660, client a reads from the line. Valid bit a was set to invalid so the line is reread from memory. The data value 25 arrives to show that the state of memory had changed and the latest value is seen. In sequence 670, client b requests an invalidation and its valid bit changes to the invalid state. In sequence 680, client b performs a read and reloads the line: the symmetric operation to that seen for client a in sequence 660. In sequence 690, a write of the value 0 to the line is illustrates. Note that the write causes no changes to the validity of the line for any client, only a change to the dirty state.

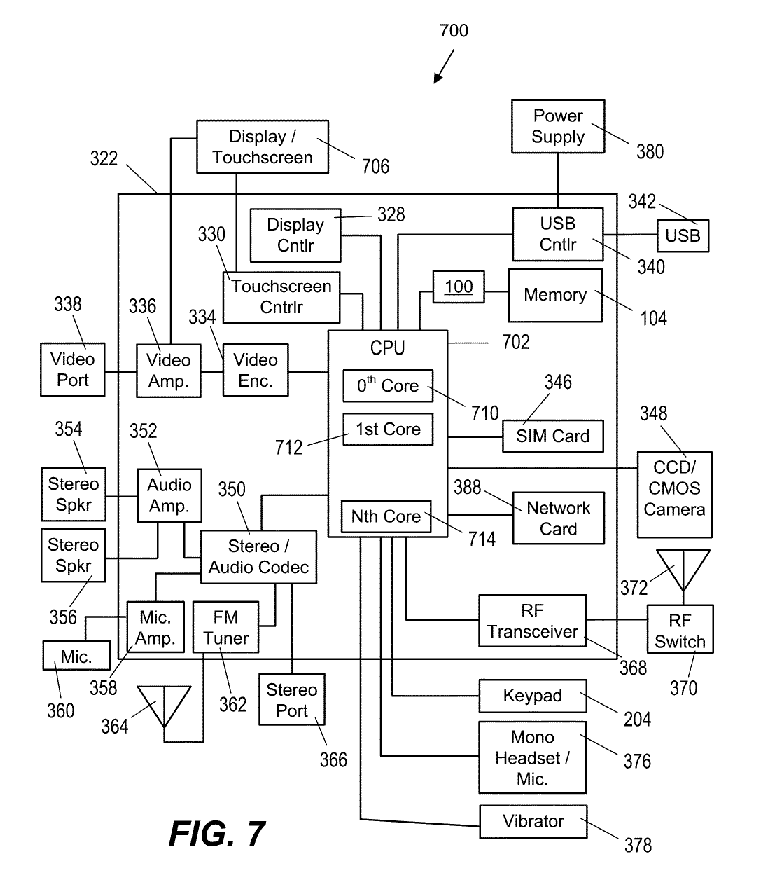

As mentioned above, the cache system 100 may be incorporated into any desirable computing system. FIG. 7 illustrates the cache system 100 incorporated in an exemplary portable computing device (PCD) 700. The SoC 322 may include a multicore CPU 702. The multicore CPU 702 may include a zeroth core 710, a first core 712, and an Nth core 714. One of the cores may comprise, for example, a graphics processing unit (GPU) with one or more of the others comprising the CPU.

A display controller 328 and a touch screen controller 330 may be coupled to the CPU 802. In turn, the touch screen display 706 external to the on-chip system 322 may be coupled to the display controller 328 and the touch screen controller 330.

FIG. 7 further shows that a video encoder 334, e.g., a phase alternating line (PAL) encoder, a sequential color a memoire (SECAM) encoder, or a national television system(s) committee (NTSC) encoder, is coupled to the multicore CPU 702. Further, a video amplifier 336 is coupled to the video encoder 334 and the touch screen display 706. Also, a video port 338 is coupled to the video amplifier 336. As shown in FIG. 7, a universal serial bus (USB) controller 340 is coupled to the multicore CPU 702. Also, a USB port 342 is coupled to the USB controller 340. Memory 104 and a subscriber identity module (SIM) card 346 may also be coupled to the multicore CPU 702. Memory 104 may reside on the SoC 322 or be coupled to the SoC 322.

Further, as shown in FIG. 7, a digital camera 348 may be coupled to the multicore CPU 702. In an exemplary aspect, the digital camera 348 is a charge-coupled device (CCD) camera or a complementary metal-oxide semiconductor (CMOS) camera.

As further illustrated in FIG. 7, a stereo audio coder-decoder (CODEC) 350 may be coupled to the multicore CPU 702. Moreover, an audio amplifier 352 may coupled to the stereo audio CODEC 350. In an exemplary aspect, a first stereo speaker 354 and a second stereo speaker 356 are coupled to the audio amplifier 352. FIG. 7 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 7 further illustrates that a radio frequency (RF) transceiver 368 may be coupled to the multicore CPU 702. An RF switch 370 may be coupled to the RF transceiver 368 and an RF antenna 372. A keypad 204 may be coupled to the multicore CPU 702. Also, a mono headset with a microphone 376 may be coupled to the multicore CPU 702. Further, a vibrator device 378 may be coupled to the multicore CPU 802.

FIG. 7 also shows that a power supply 380 may be coupled to the on-chip system 322. In a particular aspect, the power supply 380 is a direct current (DC) power supply that provides power to the various components of the PCD 700 that require power. Further, in a particular aspect, the power supply is a rechargeable DC battery or a DC power supply that is derived from an alternating current (AC) to DC transformer that is connected to an AC power source.

FIG. 7 further indicates that the PCD 700 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 7, the touch screen display 706, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for invalidating cache line data in a cache entry, the method comprising:
generating a cache entry comprising cache line data for a plurality of cache clients;
setting a data valid/invalid state for each of the plurality of clients to a valid state;
receiving a cache invalidate instruction from a first of the plurality of cache clients;
in response to the cache invalidate instruction, changing the data valid/invalid state for the first cache client to an invalid state without modifying the data valid/invalid state for the other of the plurality of cache clients from the valid state;
receiving a read instruction to the cache entry from a second of the plurality of cache clients; and
in response to the read instruction, returning a value stored in the cache line data to the second cache client while the data valid/invalid state for the first cache client is in the invalid state and the data valid/invalid state for the second cache client is in the valid state.

2. The method of claim 1, wherein the data valid/invalid state for each of the plurality of clients is controlled by a corresponding valid bit in the cache entry.

3. The method of claim 1, wherein the cache entry comprises a plurality of valid bits with each valid bit associated with a corresponding one of the plurality of cache clients, each valid bit defining the data valid/invalid state.

4. The method of claim 1, wherein the receiving the cache invalidate instruction comprises determining a client identifier associated with the first cache client.

5. The method of claim 1, further comprising:
receiving a read instruction to the cache entry from the first cache client;
if the first cache client is in the invalid state, generate a read request to a next level of a cache hierarchy.

6. The method of claim 5, wherein the next level of the cache hierarchy comprises a system memory.

7. The method of claim 1, wherein the plurality of cache clients comprises a plurality of programming threads associated with a processor.

8. The method of claim 7, wherein processor comprises one or more of a central processing unit (CPU), a graphics processing unit (GPU), and a digital signal processor (DSP).

9. A system for invalidating cache line data in a cache entry, the system comprising:
means for generating a cache entry comprising cache line data for a plurality of cache clients;
means for setting a data valid/invalid state for each of the plurality of clients to a valid state;
means for receiving a cache invalidate instruction from a first of the plurality of cache clients;
means for changing the data valid/invalid state for the first cache client to an invalid state in response to the cache invalidate instruction without modifying the data valid/invalid state for the other of the plurality of cache clients from the valid state;
means for receiving a read instruction to the cache entry from a second of the plurality of cache clients; and
means for returning, in response to the read instruction, a value stored in the cache line data to the second cache client while the data valid/invalid state for the first cache client is in the invalid state and the data valid/invalid state for the second cache client is in the valid state.

10. The system of claim 9, wherein the data valid/invalid state for each of the plurality of clients is determined by a corresponding valid bit in the cache entry.

11. The system of claim 9, wherein the cache entry comprises a plurality of valid bits with each valid bit associated with a corresponding one of the plurality of cache clients, each valid bit defining the data valid/invalid state.

12. The system of claim 9, wherein the means for receiving the cache invalidate instruction comprises means for determining a client identifier associated with the first cache client.

13. The system of claim 9, further comprising:
means for receiving a read instruction to the cache entry from the first cache client;
if the first cache client is in the invalid state, generate a read request to a next level of a cache hierarchy.

14. The system of claim 13, wherein the next level of the cache hierarchy comprises a system memory.

15. The system of claim 9, wherein the plurality of cache clients comprises a plurality of programming threads associated with a processor.

16. The system of claim 15, wherein processor comprises one or more of a central processing unit (CPU), a graphics processing unit (GPU), and a digital signal processor (DSP).

17. A system for invalidating cache line data in a cache entry, the system comprising:
a plurality of memory clients for accessing a main memory; and
a cache controller for transferring data between the main memory and a cache memory, the cache controller comprising a client-filtered cache invalidation component comprising logic configured to:
generate a cache entry in the cache memory, the cache entry comprising cache line data for a plurality of cache clients;
set a data valid/invalid state for each of the plurality of clients to a valid state;
receive a cache invalidate instruction from a first of the plurality of cache clients;
in response to the cache invalidate instruction, change the data valid/invalid state for the first cache client to an invalid state without modifying the data valid/invalid state for the other of the plurality of cache clients from the valid state;
receive a read instruction to the cache entry from a second of the plurality of cache clients; and
in response to the read instruction, return a value stored in the cache line data to the second cache client while the data valid/invalid state for the first cache client is in the invalid state and the data valid/invalid state for the second cache client is in the valid state.

18. The system of claim 17, wherein the data valid/invalid state for each of the plurality of clients is controlled by a corresponding valid bit in the cache entry.

19. The system of claim 17, wherein the cache entry comprises a plurality of valid bits with each valid bit associated with a corresponding one of the plurality of cache clients, each valid bit defining the data valid/invalid state.

20. The system of claim 17, wherein the logic configured to receive the cache invalidate instruction comprises logic configured to determine a client identifier associated with the first cache client.
